(19) United States
(12) Patent Application Publication
(10) Pub. No.: US 2025/0079717 A1
(43) Pub. Date: Mar. 6, 2025

(54) Bidirectionally Integrated Guiding Metasurface Angle Compactor

(71) Applicant: Raytheon Company, Waltham, MA (US)

(72) Inventors: Scott Randall Sorbel, Waltham, MA (US); Tamara A. Hatch, Waltham, MA (US)

(21) Appl. No.: 18/458,145

(22) Filed: Aug. 29, 2023

(51) Int. Cl. H01Q 15/02; H01Q 1/36

(52) U.S. Cl. CPC H01Q 15/02; H01Q 1/364

(57) ABSTRACT

A system that allows for electromagnetic energy to be “re-routed” around normally occlusive structures. The system comprises a first multilayer metasurface device and a second multilayer metasurface device. The first multilayer metasurface device has a plurality of wave refractors fabricated on a first metasurface and a plurality of wave combiners fabricated on a second metasurface. The second multilayer metasurface device has a plurality of wave splitters fabricated on a first metasurface and a plurality of wave refractors fabricated on a second metasurface. The occlusive structures are disposed between the first multilayer metasurface device and the second multilayer metasurface device such that energy is re-routed around the occlusive structures.

### BACKGROUND

Electromagnetic (EM) metasurfaces have a history as early as in the 1900's such as in the reflection spectra of subwavelength metallic gratings which had shown dark areas. This unusual effect led to the discovery of the surface plasmon polariton (a particular electromagnetic wave excited at metal/dielectric interfaces). In addition, subwavelength-thick films can also produce dramatic changes in electromagnetic boundary conditions. Metasurfaces can include some traditional concepts in the microwave spectrum such as frequency selective surfaces (FSS), impedance sheets and even Ohmic sheets as well. For EM waves in the microwave regime, the thickness of these metasurfaces can be much smaller than the wavelength of operation (for example, 1/1000 of the wavelength), since the skin depth could be extremely small for highly conductive metals.

Metasurfaces, in general, may be thought of as two dimensional (or one-dimensional) metamaterials (which are 3D constructs that are made up of at least two or more materials). A metamaterial is a sub-wavelength structure that allows for the control of wave physics. This control may be in the form of changing the wave direction (refraction, typically with the real part of a material parameter) or in attenuation (absorption, typically with the imaginary part of a material parameter). The materials are usually arranged in repeating and non-repeated patterns at scales that are smaller than the wavelengths of the phenomena they influence. Metamaterials acquire their properties not from the properties of the base materials, but from their newly designed structures with effective properties at a larger scale (typically macro-scale level). Their shape, geometry, size, orientation, and placement allow one to control acoustic, electromagnetic, or any other type of wave. This is done by blocking, absorbing, enhancing, or bending waves that achieve characteristics not normally possible with conventional materials. Appropriately designed metamaterials can affect waves of electromagnetic radiation or sound in a manner not observed in bulk materials. Metasurfaces are metamaterials but typically designed on a 2D surface only (metamaterials are typically designed as 3D structures).

Energy output of electromagnetic systems is sometimes diminished by structures in the system that block some of the electromagnetic energy. Referring to FIG. 1, there is shown electromagnetic waves 10 interacting with a structure 12 of an electromagnetic system. In an embodiment, the structure 12 can comprise an aperture, such as an aperture with a lattice or matrix. As can be seen, some of the electromagnetic waves 10 are reflected by the structure 12 from their original path of travel and are lost to the system. In some instances, the structure 12 can reduce the energy output of the system by up to 20% or more. Based on the foregoing, it would be advantageous to provide an improvement in energy output of an electromagnetic system using metasurfaces to redirect or reroute energy around structures that would otherwise block wave transmission.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 shows a structure that forms an obstruction in the path of electromagnetic energy such that the structure blocks transmission of part of the electromagnetic energy.

FIG. 2 shows the use of two multilayer metasurface devices to re-route electromagnetic energy around a structure according to an embodiment of the present disclosure.

FIG. 3 shows a perspective view of a trapezoidal antenna structure fabricated on a substrate, the trapezoidal antenna can be used as a wave refractor, a wave combiner, and a wave splitter.

FIG. 4 shows a diagram of a trapezoidal antenna structure being used to refract an incoming electromagnetic wave.

FIG. 5 shows a diagram of a trapezoidal antenna structure being used to combine two incoming electromagnetic waves.

FIG. 6 shows an isometric view of a multilayer metasurface device having wave refractors disposed on its top surface and wave combiners disposed on its bottom surface.

FIG. 7 is a diagram showing the wave paths through the multilayer metasurface device shown in FIG. 6.

FIG. 8 is a view of an aperture to which multilayer metasurface devices can be adhesively bonded.

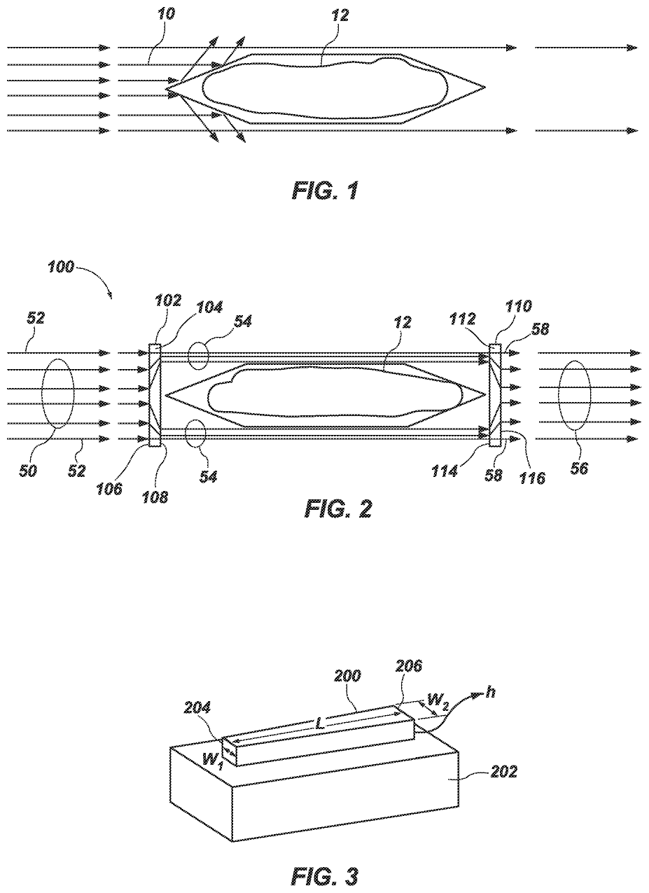

Reference will now be made to the examples illustrated, and specific language will be used herein to describe the same. It will nevertheless be understood that no limitation of the scope of the invention is thereby intended.

### SUMMARY

An initial overview of the inventive concepts is provided here, and then specific examples are described in further detail later. This initial summary is intended to aid readers in understanding the examples more quickly and is not intended to identify key features or essential features of the examples, nor is it intended to limit the scope of the claimed subject matter.

In one example, the present disclosure sets forth a multilayer metasurface device that allows for electromagnetic waves to be “re-routed” around normally occlusive surfaces, in a sub-wavelength sense that allows more energy to pass through, in an innovative multilayer metasurface system. The present disclosure can be applied to any electromagnetic wave (e.g., Radio Frequency to Ultraviolet and beyond).

In another example, the present disclosure sets forth a multilayer metasurface device having a first metasurface formed on one side and a second metasurface formed on the opposite side. The first metasurface can have a plurality of microfabricated wave refractors. The second metasurface can have a plurality of microfabricated wave combiners.

In another example, the present disclosure sets forth a multilayer metasurface device having a first metasurface formed on one side and a second metasurface formed on the opposite side. The first metasurface can have a plurality of microfabricated wave splitters. The second metasurface can have a plurality of microfabricated wave refractors.

In another example, the present disclosure sets forth a multilayer metasurface device having a first metasurface formed on one side and a second metasurface formed on the opposite side. The first metasurface can have a plurality of microfabricated trapezoidal antennas. The second metasurface can have a plurality of microfabricated trapezoidal antennas.

In another example, the present disclosure sets forth a multilayer metasurface device having a first metasurface formed on one side and a second metasurface formed on the opposite side. The first metasurface can have a plurality of microfabricated antennas of any configuration and shape suitable to facilitate the functionality of the multilayer metasurface device. The second metasurface can have a plurality of microfabricated antennas of any configuration and shape suitable to facilitate the functionality of the multilayer metasurface device.

In another example, the present disclosure sets forth a system for re-routing electromagnetic waves around a structure, such an aperture matrix. The system includes a first multilayer metasurface device bonded to the front of the structure and a second multilayer metasurface bonded on the back of the structure. The first multilayer metasurface device and the second multilayer metasurface operate collectively to re-route electromagnetic waves around the structure to minimize obstruction and energy loss.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. In contexts where elements are recited to be “substantially aligned with” another element recited herein, it is intended that the recited element is still “substantially aligned with” another element when the element is either in perfect alignment with, or out of alignment by +/−10 degrees with the other element. In contexts where elements are recited to be “substantially parallel” to another element recited herein, it is intended that the recited element is still “substantially parallel” to the other element when the element is either perfectly parallel with, or is angled away from parallel with the other element by +/−10 degrees.

As used herein, “adjacent” refers to the proximity of two structures or elements. Particularly, elements that are identified as being “adjacent” can be either abutting or connected. Such elements can also be near or close to each other without necessarily contacting each other. The exact degree of proximity can in some cases depend on the specific context.

As used herein, “about” refers to within +/−10 percent of a stated value.

As used herein, “metasurface” refers to a type of artificial material with sub-wavelength thickness that enables the manipulation of the phase, amplitude, and polarization of energy to refract, combine, and split the energy.

As used herein, “multilayer metasurface device” is a device or structure that has two or more metasurfaces. For example, a “multilayer metasurface device” can include a substrate having a first metasurface fabricated on one side and a second metasurface fabricated on the opposite side.

As used herein, “refractor” or “wave refractor” refers to structure(s) on a metasurface that redirects a wave of energy at an angle with respect to its original path.

As used herein, “combiner” or “wave combiner” refers to structure(s) on a metasurface that combines two or more waves of energy into a single wave.

As used herein, “splitter” or “wave splitter” refers to structure(s) on a metasurface that splits a wave of energy into two or more waves traveling in different directions.

It will be appreciated that a “wave refractor,” “wave combiner,” and “wave splitter” can have the same geometry or topology and that the functionality is dependent on the direction of the energy wave input into the structure.

As used herein, “electromagnetic wave” or “electromagnetic energy” or “energy” refers to any wavelength of electromagnetic radiation, including radio frequencies to ultraviolet and beyond.

To further describe the present technology, examples are now provided with reference to the figures. As shown in FIG. 2, a system 100 is utilized to re-route electromagnetic waves 50 around the structure 12. According to an aspect of the present disclosure, the structure 12 can be a meshed aperture or veins. The system 100 includes a first multilayer metasurface device 102 on an “input” side of the structure and a second multilayer metasurface device 110 on an “output” side of the structure 12. That is, the structure 12 is disposed between the first multilayer metasurface device 102, which is on the input side, and the second multilayer metasurface device 110, which is on the output side, of the system 100.

The first multilayer metasurface device 102 redirects the waves 50 that would otherwise be blocked by the structure 12. The first multilayer metasurface device 102 also combines the redirected waves 50 with waves 52 that would not be blocked by the structure 12 to form combined waves 54. That is, the first multilayer metasurface device 102 allows waves 52 that would not be obstructed by the structure 12 to propagate along their original path. Once the combined waves 54 have passed the structure 12, the second multilayer metasurface device 110 splits the combined waves 54 such that a first portion of the waves 56 travels along the original path of the obstructed waves 50, and a second portion of the waves 58 travels along the original path of the unobstructed waves 52. It will be appreciated that the output from the system 100 forms a substantially uniform distribution despite the presence of the structure 12 due to the re-routing of the waves. However, some energy will be lost, but less than if the system 100 was not employed.

Each of the first multilayer metasurface device 102 and the second multilayer metasurface device 110 will now be described. The first multilayer metasurface device 102 can comprise a substrate 104 having a first metasurface 106 on one side and a second metasurface 108 on the opposite side. The substrate 104 can be formed of silica or other suitable material. The first metasurface 106 can be formed on the “input” side of the first multilayer metasurface device 102 and can comprise a plurality of wave refactors fabricated thereon using microfabrication techniques. The wave refactors can be operable to refract electromagnetic waves at an outward angle with respect to a normal axis of the first metasurface 106. In an embodiment, the angle is between 40 and 50 degrees, or about 45 degrees. However, other angles are possible, including angles between 30 and 60 degrees, between 20 and 70 degrees, between 10 and 80 degrees, between 5 and 85 degrees, between 1 degree and 89 degrees, between 1 and 80 degrees, between 1 and 70 degrees, between 1 and 60 degrees, between 1 and 50 degrees, between 1 and 40 degrees, between 1 and 30 degrees, between 1 and 20 degrees, and between 1 and 10 degrees. In an embodiment, the angle is an acute angle greater than 0 degrees. The second metasurface 108 can be formed on the “output” side of the first multilayer metasurface device 102 and can comprise a plurality of wave combiners fabricated thereon using microfabrication techniques. The wave combiners can combine refracted and unrefracted waves and output combined waves parallel to the structure 12.

The second multilayer metasurface device 110 can comprise a substrate 112 having a first metasurface 114 and a second metasurface 116. The substrate 112 can be formed of silica or other suitable material. The first metasurface 114 can be formed on the “input” side of the second multilayer metasurface device 110 and can comprise a plurality of wave splitters fabricated thereon using microfabrication techniques. The wave splitters can be operable to refract a first portion of the incoming electromagnetic waves at an inward angle with respect to a normal axis of the first metasurface 114. In an embodiment, the angle is between 40 and 50 degrees, or about 45 degrees. However, other angles are possible, including angles between 1 degree and 89 degrees. In an embodiment, the angle is an acute angle greater than 0 degrees. A second portion of the incoming electromagnetic waves can be output from the wave splitters parallel to their original direction of travel. That is, these waves pass through the wave splitters. The second metasurface 116 can be formed on the “output” side of the second multilayer metasurface device 110 and can comprise a plurality of wave refractors fabricated thereon using microfabrication techniques. The wave refractors can output electromagnetic waves from the wave splitters parallel to their original direction of travel.

Referring to FIG. 3, there is shown a trapezoidal silicon antenna 200 fabricated on a substrate 202 that is suitable for use as a wave refractor, wave combiner, and wave splitter on a metasurface pursuant to an embodiment of the present disclosure. That is, one antenna topology can be utilized in refracting, combining, and splitting electromagnetic waves. It will be appreciated that the use of a single topology simplifies manufacturing. Of course, other topologies of an antennas can be utilized. The antenna 200 can be fabricated using microfabrication processes.

The antenna 200 can comprise a first end 204 having a first width, W1, a second end 206 having a second width, W2, a length, L, and a height, h. Due to the differences in the first width, W1, and the second width, W2, the antenna 200 has a substantially trapezoidal shape. In an embodiment, the first width, W1, is between 50 and 80 nanometers, or about 66 nanometers. In an embodiment, the second width, W2, is between 140 and 170 nanometers, or about 154 nanometers. In an embodiment, the length, L, is between 700 and 1000 nanometers, or about 850 nanometers. In an embodiment, the height, h, is between 80 and 100 nanometers, or about 91 nanometers. Further, it will be appreciated by those skilled in the art that the antenna 200 can comprise a shape and configuration other than trapezoidal, and that a trapezoidal shape and configuration is merely an example, and not intended to be limiting in any way.

It will be appreciated that the operational window of the antenna 200 falls in the infrared and visible region, respectively, for x- and y-polarized light, resulting from the different mechanisms. Past devices have found that when x-polarized light is incident on the metasurface-based wave splitter, the conversion efficiency and total transmission of the wave splitter remains higher than 90% and 0.74 within the wavelength range from 969 nm to 1054 nm, respectively. For y-polarized incidence, the maximum conversion efficiency and transmission reach approximately 100% and 0.85, while the values remain higher than 90% and 0.65 in the wavelength range from 687 nm to 710 nm, respectively. In this case, each antenna 200 can be viewed as an effective wave deflector for photonic applications that require minimal material.

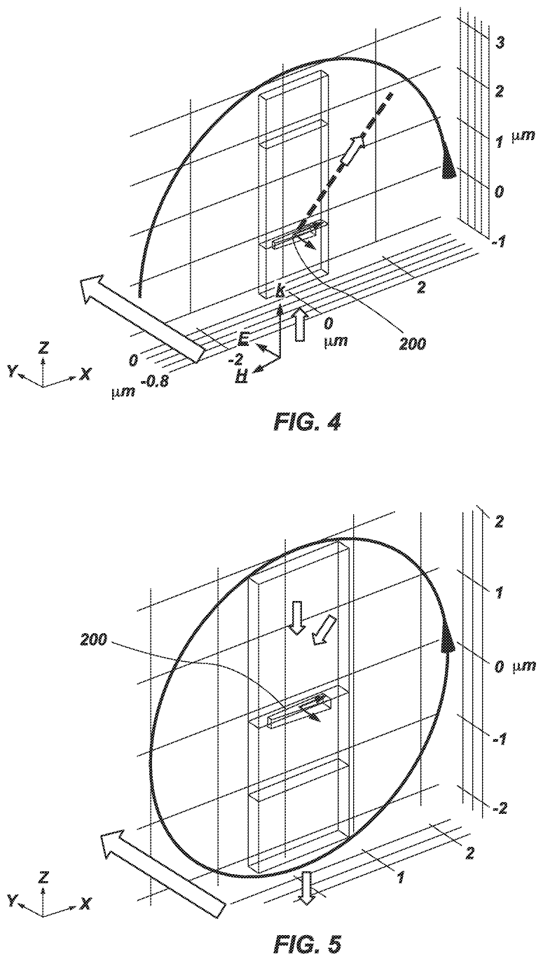

As shown in FIG. 4, the antenna 200 can be utilized as a refractor. As shown, an incoming electromagnetic wave (input coming from below, output being refracted above) and polarized along the y-axis is refracted by the antenna 200 at an angle. In an embodiment, the angle is between 40 and 50 degrees, or about 45 degrees. However, other angles are possible, including angles between 30 and 60 degrees, between 20 and 70 degrees, between 10 and 80 degrees, between 5 and 85 degrees, between 1 degree and 89 degrees, between 1 and 80 degrees, between 1 and 70 degrees, between 1 and 60 degrees, between 1 and 50 degrees, between 1 and 40 degrees, between 1 and 30 degrees, between 1 and 20 degrees, and between 1 and 10 degrees. In an embodiment, the angle is an acute angle greater than 0 degrees. As shown in FIG. 5, the antenna 200 can be utilized as a combiner. As shown, two incoming electromagnetic waves (input coming from above, output being directed downward) and polarized along the y-axis are combined by the antenna 200. Likewise, it will be appreciated that the antenna 200 can be utilized as a splitter by reversing the direction of the waves in FIG. 5. That is, the antenna 200 can split an incoming wave into two output waves.

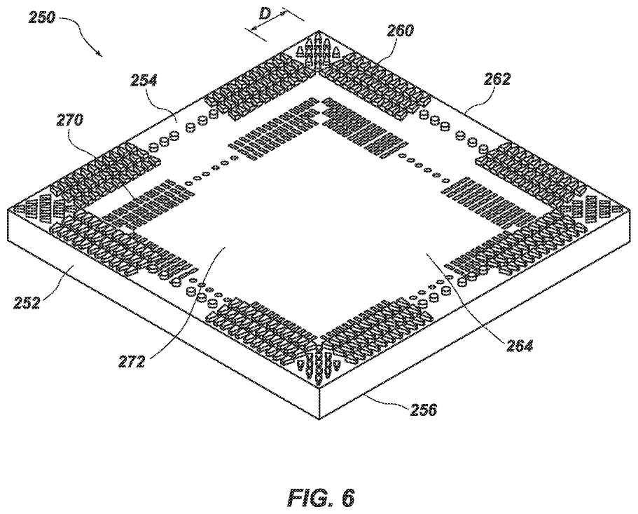

Referring now to FIG. 6, there is depicted a multilayer metasurface device 250 having a substrate 252. The substrate 252 can have a first metasurface 254 formed on its top side and a second metasurface 256 formed on its underside. A distance between the first metasurface 254 and the second metasurface 256 can define a substrate thickness, which thickness can be any thickness capable of facilitating the functionality of the multilayer metasurface device 250 described herein. Indeed, the substrate thickness can be any thickness that is sufficiently transparent to permit the passage of electromagnetic waves (e.g., light) therethrough, and also capable of supporting the antennas thereon. Those skilled in the art will recognize that the thickness of the substrate may be different for different applications and/or configurations of the multilayer metasurface device 250. In an embodiment, the substrate thickness can be between 100 and 900 microns, between 100 and 800 microns, between 100 and 700 microns, between 100 and 600 microns, between 100 and 500 microns, between 100 and 400 microns, between 100 and 300 microns, between 100 and 200 microns. In a specific example, the thickness can be about 250 microns. Again, it will be appreciated that the substrate can be any thickness, as long as it is transparent enough to allow electromagnetic waves through and strong enough to hold or support the sub wavelength antennas on each side. For RF applications, the thickness can be thin, such as 500 microns to 100 microns. For visible light, a comparable thickness can be determined or provided, again depending upon the application and/or the configuration of the multilayer metasurface device 250.

Fabricated on the first metasurface 254 is a plurality of wave refractors 260 (dots show a continuation of the pattern). It will be appreciated that each of the wave refractors 260 may, but not necessarily, take the form of the antenna 200 shown and described above (see FIG. 4). The wave refractors 260 are located adjacent to a perimeter 262 of the first metasurface 254 and form a rectangular shape. A depth, D, of the wave refractors 260 from the perimeter 262 is sufficient to align with the waves that would otherwise be obstructed by the structure. An interior area 264 on the first metasurface 254 is devoid of wave refractors 260. In this regard, the wave refractors 260 surround the interior area 264.

Fabricated on the second metasurface 256 is a plurality of wave combiners 270. It will be appreciated that each of the wave combiners 270 may, but not necessarily, take the form of the antenna 200 shown and described above. The wave combiners 270 are spaced from the perimeter 262 by a distance D. The wave combiners 270 are located directly beneath the interior area 264 on the first metasurface 254. In addition, an interior area 272 on the second metasurface 256 is devoid of wave combiners 270. That is, the wave combiners 270 surround the interior area 272. (Note that the wave combiners 270 and the interior area 272 are on the underside of the device 250).

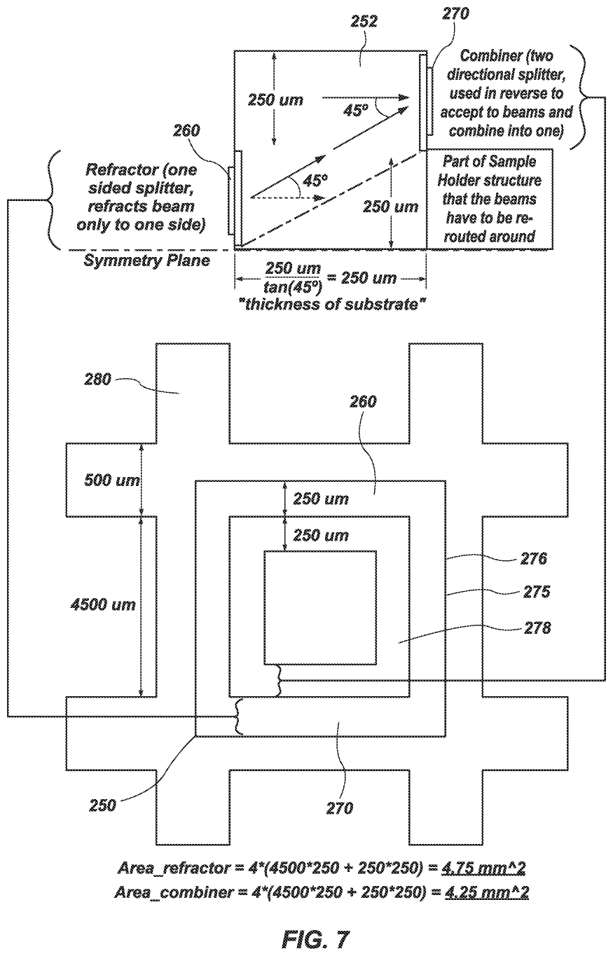

Referring to FIG. 7, a footprint 275 of the multilayer metasurface device 250 is shown mounted on a unit cell of a structure 280. As shown, a footprint 276 of the wave refractors 260 around the perimeter 262 is about one-half of the thickness of the lattice work of the structure 280. It will be appreciated that this allows multiple multilayer metasurface devices 250 to be used on the structure 280. As shown, a footprint 278 of the wave combiners 270 is inside of the wave refractors 260. Thus, the wave combiners 270 are located inside of the wave refractors 260, but on the opposite surface.

FIG. 7 further shows that the wave refractors 260 refract input waves at an angle of 45 degrees through the substrate 252. The refracted waves are then combined with the unrefracted waves by the wave combiners 270. The combined waves are then output parallel to the input waves (see FIG. 2).

It will be appreciated that the multilayer metasurface device 250 can be used on both the input side and the output side of a system for re-routing electromagnetic waves around a structure as shown and described in reference to FIG. 2, above.

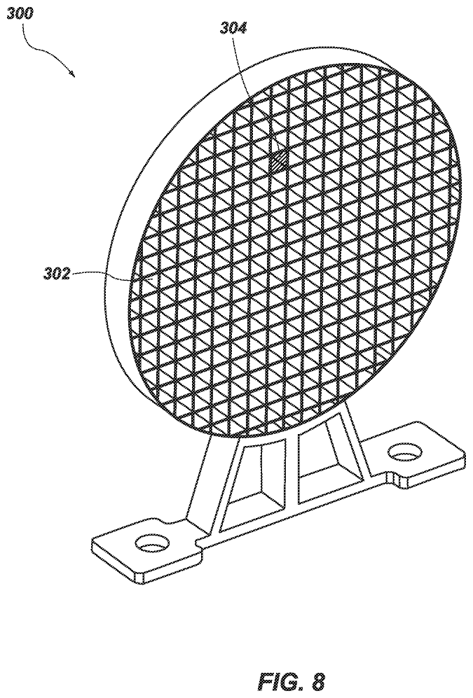

Referring to FIG. 8, there is shown an aperture 300 having a plurality of unit cells 302 having a rectangular shape. It will be appreciated that a multilayer metasurface device 304 according to the present disclosure can be fabricated to cover both sides of the unit cells 302 using either a single multilayer metasurface device or plurality of multilayer metasurface devices on each side. That is, a multilayer metasurface device according to the present disclosure can be sized to cover one of the unit cells 302, multiple unit cells 302, or all of the unit cells 302. The multilayer metasurface device can be bonded to the aperture 300. As explained herein, the multilayer metasurface device(s) can re-route incoming waves around the lattice work of the aperture 300. It will be appreciated that although the unit cells 302 are shown having a rectangular shape, they can have almost any two-dimensional shape, including a hexagonal, pentagonal, triangular or octagonal shape.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein can be combined with other embodiments or features described herein, this disclosure should be read to describe any such combinations that would be practicable by one of ordinary skill in the art. The use of “or” in this disclosure should be understood to mean non-exclusive or, e.g., “and/or,” unless otherwise indicated herein.

Furthermore, the described features, structures, or characteristics can be combined in any suitable manner in one or more examples. In the preceding description, numerous specific details were provided, such as examples of various configurations to provide a thorough understanding of examples of the described technology. It will be recognized, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A multilayer metasurface device comprising:
a substrate having a first metasurface and a second metasurface;
a plurality of wave refractors fabricated on the first metasurface; and
a plurality of wave combiners fabricated on the second metasurface.

2. The multilayer metasurface device of claim 1, wherein a distance between the first metasurface and the second metasurface defines a substrate thickness, wherein the substrate thickness is sufficient to permit the passage of electromagnetic waves therethrough.

3. The multilayer metasurface device of claim 1, wherein the first metasurface of the substrate has a normal axis, wherein a wave path between one of the plurality of wave refractors and one of the plurality of wave combiners defines an angle between at least one of 40 and 50 degrees, 30 and 60 degrees, 20 and 70 degrees, 10 and 80 degrees, 5 and 85 degrees, 1 degree and 89 degrees, 1 and 80 degrees, 1 and 70 degrees, 1 and 60 degrees, 1 and 50 degrees, 1 and 40 degrees, 1 and 30 degrees, 1 and 20 degrees, and 1 and 10 degrees relative to the normal axis

4. The multilayer metasurface device of claim 1, wherein each of the plurality of wave refractors comprises an antenna.

5. The multilayer metasurface device of claim 1, wherein each of the plurality of wave combiners comprises an antenna.

6. The multilayer metasurface device of claim 1, wherein the first metasurface comprises a first area devoid of wave refractors, wherein the plurality of wave combiners is located on the second metasurface directly beneath the first area.

7. The multilayer metasurface device of claim 6, wherein the plurality of wave refactors surround the first area on the first metasurface.

8. The multilayer metasurface device of claim 7, wherein the second metasurface comprises a second area devoid of wave combiners, wherein the plurality of wave combiners surround the second area on the second surface.

9. A system comprising:
a structure having a first end and a second end;
a first device comprising a first substrate having a first surface and a second surface, a first plurality of wave refractors fabricated on the first surface, and a first plurality of wave combiners fabricated on the second surface;
a second device comprising a second substrate having a third surface and a fourth surface, a first plurality of wave splitters fabricated on the third surface, and a second plurality of wave refractors fabricated on the fourth surface;
wherein the structure is disposed between the first device and the second device;
wherein the first device and the second device define a wave path that re-routes electromagnetic waves around the structure.

10. The system of claim 9, wherein a distance between the first surface and the second surface of the first device defines a substrate thickness, wherein the substrate thickness is sufficient to permit the passage of electromagnetic waves therethrough.

11. The system of claim 9, wherein the first substrate of the first device has a first normal axis, wherein a wave path between a wave refractor and a wave combiner of the first device defines a first angle between at least one of 40 degrees and 50 degrees, 30 and 60 degrees, 20 and 70 degrees, 10 and 80 degrees, 5 and 85 degrees, 1 degree and 89 degrees, 1 and 80 degrees, 1 and 70 degrees, 1 and 60 degrees, 1 and 50 degrees, 1 and 40 degrees, 1 and 30 degrees, 1 and 20 degrees, and 1 and 10 with the first normal axis; and
wherein the second substrate of the second device has a second normal axis, wherein a wave path between a wave splitter and a wave refractor of the second device defines a second angle between 40 degrees and 50 degrees with the second normal axis.

12. The system of claim 9, wherein each of the first plurality wave refractors and each of the first plurality of wave combiners comprises an antenna.

13. The system of claim 9, wherein each of the first plurality wave splitters and each of the second plurality of wave refactors comprises an antenna.

14. The system of claim 9, wherein the first surface of the first device comprises a first area devoid of wave refractors, wherein the first plurality of wave combiners are located on the second surface directly beneath the first area.

15. The system of claim 14, wherein the first plurality of wave refactors surround the first area on the first surface of the first device.

16. The system of claim 15, wherein the second surface of the first device comprises a second area devoid of wave combiners, wherein the first plurality of wave combiners surround the second area on the second surface of the first device.

17. A method of re-routing electromagnetic waves around a structure, the method comprising:
refracting electromagnetic waves heading towards the structure at a first angle using a first plurality of wave refractors fabricated on a first substrate;
combining the refracted electromagnetic waves with unrefracted electromagnetic waves using a first plurality of wave combiners fabricated on the first substrate such that the combined electromagnetic waves bypass the structure;
splitting the combined electromagnetic waves using a first plurality of wave splitters fabricated on a second substrate such that a part of the combined electromagnetic waves is re-directed at a second angle; and
refracting the re-directed electromagnetic waves using a second plurality of wave refactors fabricated on the second substrate.

18. The method of claim 17, wherein the first plurality of wave refractors is fabricated on a first surface of the first substrate, and wherein the first plurality of wave combiners is fabricated on a second surface of the first substrate.

19. The method of claim 18, wherein the first plurality of wave splitters is fabricated on a first surface of the second substrate, and wherein the second plurality of wave refractors is fabricated on a second surface of the second substrate.

20. The method of claim 19, wherein the structure is disposed between the first substrate and the second substrate.
